(19) United States
(12) Patent Application Publication
(10) Pub. No.: US 2019/0389601 A1
(43) Pub. Date: Dec. 26, 2019

(54) PROJECTOR FOR IDENTIFYING STRUCTURAL ITEMS BEHIND A FUSELAGE OF AN AIRCRAFT AND A RELATED METHOD

(71) Applicant: AIRBUS OPERATIONS S.L., Madrid (ES)

(72) Inventors: Pedro VALERA RODRIGUEZ, Madrid (ES); Alejandro ROSIQUE GOMEZ, Madrid (ES)

(21) Appl. No.: 16/444,669

(22) Filed: Jun. 18, 2019

(30) Foreign Application Priority Data
Jun. 21, 2018 (EP) 18382458-0

(51) Int. Cl. B64F 5/60; B64C 1/12; H04N 5/74; B64C 1/06; G06K 9/46

(52) U.S. Cl. CPC B64F 5/60; B64C 1/12; G06K 9/4647; B64C 1/061; H04N 5/7408

(57) ABSTRACT

A projector to project a pattern on a surface of an aircraft. The projector includes software configured to read a pattern, and a projector configured to project the read pattern onto the surface of the aircraft. The pattern is a map of structural images corresponding to the structural components mounted behind the skin of the aircraft, such as a fuselage, and frame references corresponding to predetermined visible points on the skin of the aircraft. The frame references are aligned with the predetermined visible points of the fuselage to match the pattern with the aircraft and the structural items are identified based on the structural references.

### RELATED APPLICATION

This application claims priority to European Patent Application 18382458-0, filed Jun. 21, 2018, the entirety of which is incorporated by reference.

### BACKGROUND OF INVENTION

When inspecting the skin of an aircraft, it is often helpful to know the structures adjacent the inside surface of the skin. For example, if a dent is found in the skin of a fuselage it is useful to know if the dent is aligned with a stringer, a longeron or a bulkhead that may have been damaged by the strike that formed the dent in the skin. Identifying and locating structures adjacent an inside surface of a skin is difficult because the structure are not visible from the outside of the skin.

The conventional practice for identifying and locating structures adjacent the inside surface of a skin is to create maps of the skin and the structures adjacent the inside surface of the skin. When a dent in a skin is located, the maps are used to determine is the dent is aligned with structures adjacent the skin at or near the dent. Creating the maps is tedious and time consuming procedure and often results in inaccuracies in the maps. Accordingly, there is a long felt need for a device and a procedure that permits identifying structural elements and features behind the skin of a fuselage of an aircraft without the difficulties of the conventional practice.

### SUMMARY OF INVENTION

A projector has been invented that is configured to project onto an outer skin surface images of structures, or patterns represented structures, adjacent an inside surface of the skin. The projected images illustrate structural items behind a skin of an aircraft by projecting patterns of the structural items on the skin of the aircraft. The invention may also be embodied as a procedure for identifying structural items behind the skin of a fuselage of an aircraft based on the projection of patterns of those structural items onto the skin. Hence, the use of maps and sketches is no longer needed because the projection of patterns representing the structural items makes it easy to reliably locate the actual structural items behind the fuselage skin in a rapid manner. In fact, the maps and sketches are substituted by the patterns projected on the fuselage outer surface of the aircraft. In this regard, the pattern comprises structural references. The structural references identify structural items behind the fuselage of the aircraft. Structural references can be e.g. numerical references that show the location of structural elements behind the fuselage of the aircraft. Furthermore, the pattern comprises frame references that relate to predetermined visible points of the fuselage and that permit a correct alignment of the pattern with the aircraft. In this regard, frame references are intended to be superposed on the predetermined visible points of the fuselage of the aircraft. In other words, the frame references are designed to match with the predetermined visible points of the fuselage of the aircraft.

Hence, the object of the present invention is to identify items behind the fuselage of the aircraft, and for that; it is provided a device that projects a pattern that represents the structure of an aircraft on the fuselage of the aircraft. To provide accuracy and alignment between the pattern and the fuselage, frame references included in the pattern can be aligned with predetermined visible points of the fuselage to match the pattern with the aircraft. Thus, items are quickly identified ensuring the best solution during an assessment phase of the aircraft structure. Furthermore the proposed projector can be used without non-destructive testing NDT qualification to obtain the thickness or stepping of a composite skin of the fuselage of the aircraft because the proposed projector is not an NDT device.

Furthermore, the proposed projector can be used during the repair assessment, when only the outer surface of the aircraft is visible. Moreover, for any structural modification of the aircraft, the proposed projector can be used having an initial reference of the structure behind the fuselage. In some examples, systems of the aircraft more than structural elements can be projected in order to get an idea of the room and placement before unscrewing the panels.

Hence, in one aspect, the present invention refers to a projector for identifying structural items behind a fuselage of an aircraft by projecting a pattern on a surface of an aircraft. The projector comprises software means to read the pattern and projecting means to project the read pattern onto the surface of the aircraft. The pattern comprises structural references e.g. numerical elements that identify structural items behind the fuselage of the aircraft and frame references to be aligned with predetermined visible points of the fuselage of the aircraft in order to ensure accuracy. In some examples, the projector comprises supporting means that improves alignment between the projected pattern and the fuselage of the aircraft based on the frame references.

In some examples, the projector comprises optical and/or digital means to zoom in/out the read pattern to scale the projected pattern to a particular size. Scaling the pattern to a particular size permits to adapt the size of the pattern to a desired size that matches the real dimensions of fuselage of the aircraft. In this respect, the pattern can further comprise coordinate axes to measure the scale of the projected pattern to the particular size. For example, the coordinate axes may comprise two axes in millimeters.

In another aspect of the present invention, it is proposed a method for identifying structural items behind a fuselage of an aircraft based on projecting patterns on a surface of the aircraft. The method comprises a step for reading a pattern that comprises structural references that represent structural items of the aircraft and frame references used to be aligned with predetermined visible points of the fuselage. Furthermore, the method comprises steps for projecting the pattern onto the surface of the aircraft, for aligning the frame references with predetermined visible points of the fuselage of the aircraft and for identifying the structural items based on the structural references after the mentioned alignment.

Hence, the frame references are aligned with predetermined visible points of the fuselage of the aircraft to permit a correct projection of the pattern onto the fuselage of the aircraft to identify the structural items behind the fuselage of the aircraft.

In some examples, the method permits projecting at least a second pattern with at least a second projector onto the surface of the aircraft and overlapping the second pattern with the first pattern to obtain an overlapped pattern, wherein the overlapped pattern permits identifying new structural items. In some other examples, more than two patterns can be overlapped in order to obtain an overlapped pattern out of many individual patterns. Overlapped patterns can be projected onto areas of the fuselage that include e.g. curves or corners.

### SUMMARY OF THE DRAWINGS

For a better understanding the above explanation and for the sole purpose of providing an example, some non-limiting drawings are included that schematically depict a practical embodiment.

FIG. 1 shows an example of a pattern according to the present disclosure.

FIG. 2 shows a section of the pattern according to the present disclosure.

FIG. 3 shows a projection of the section of the pattern according to the present disclosure.

FIG. 4 is a schematic diagram of a computing system with a projector configured to project patterns onto a fuselage.

### DETAILED DESCRIPTION OF AN EMBODIMENT OF THE INVENTION

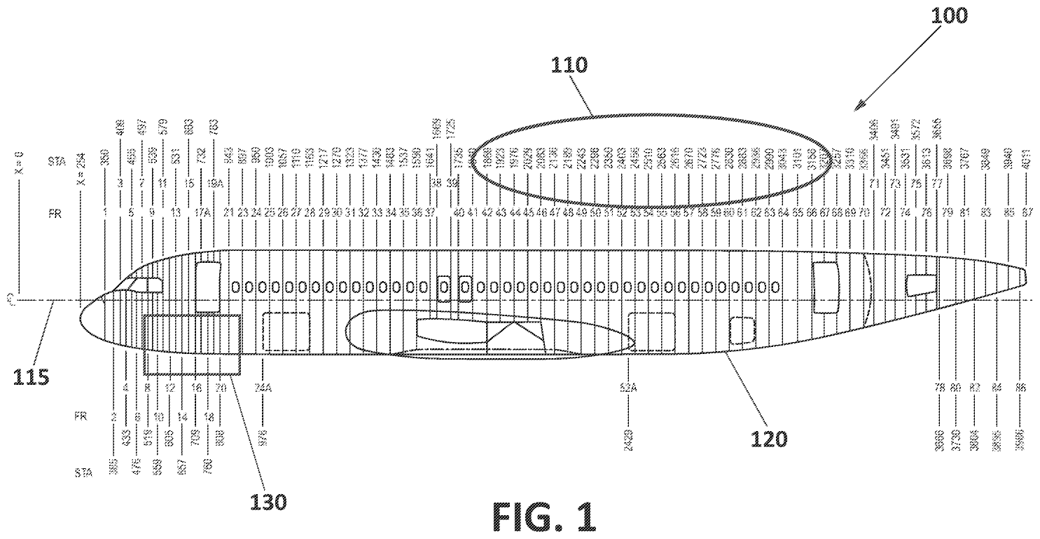

FIG. 1 shows an example of a pattern 100 according to the present disclosure. The pattern 100 can be obtained from a computing system associated with a projector (not shown in the figure) for projecting patterns according to the present disclosure. Examples of a computing system can be e.g. a laptop, a smartphone a tablet, etc. Furthermore, the projector comprises projecting means to project the read pattern onto the surface of the aircraft. The projector may be a high contrast projector. The pattern can be generated and transmitted by said computing system to the projector that comprises software to identify and retrieve the pattern from storage, and load the pattern into the projector. The software may be stored on a non-transitory device and executed by a processor or computer that retrieves the pattern from storage, reads the pattern to select the pattern 100 and configures the pattern for display by the projector. The pattern may be stored remotely from the computing system. The projector comprises wireless and non-wireless systems for receiving and loading the pattern transmitted from the computing system. The pattern 100 shows the fuselage 120 of an aircraft, numerical structural references 110 that relate to a group of structural items located behind the fuselage 120 of the aircraft and several frame references points as e.g. reference axis 115 to be aligned with predetermined visible points of the fuselage of the aircraft to accurately match the pattern with the aircraft. In some examples, the pattern 100 is based on a clad thickness and stepping of skin composites of the fuselage of the aircraft.

The group of structural items identified by the numerical structural references 110 can refer e.g. to frames, system supports, longerons, etc. In some examples, other structural elements behind the fuselage of the aircraft or even full systems of the aircraft as e.g. electric system, ventilation system, pressurization system, etc. can be spotted by the proposed projector. Furthermore, FIG. 1 shows a pattern section 130 chosen to be projected with the projector. Hence once the pattern section 130 is correctly projected onto fuselage of the aircraft, it is easy and quick to identify and locate any structure item or system behind the fuselage skin.

The equipment can be based on commercial off-the-shell (COTS) product provided by a third party in order reduce costs. The projector can include purchased software as e.g. a media player that permits the projection of any section of the pattern 100 on the surface of the aircraft. In some examples, the projector can comprise a tripod that ensures the right height for projection. The tripod also gives stability to the projector for a correct functioning of the projector and gives a proper positioning of the projector achieved by aligning the frame references with the predetermined visible points of the fuselage to match the pattern with the aircraft.

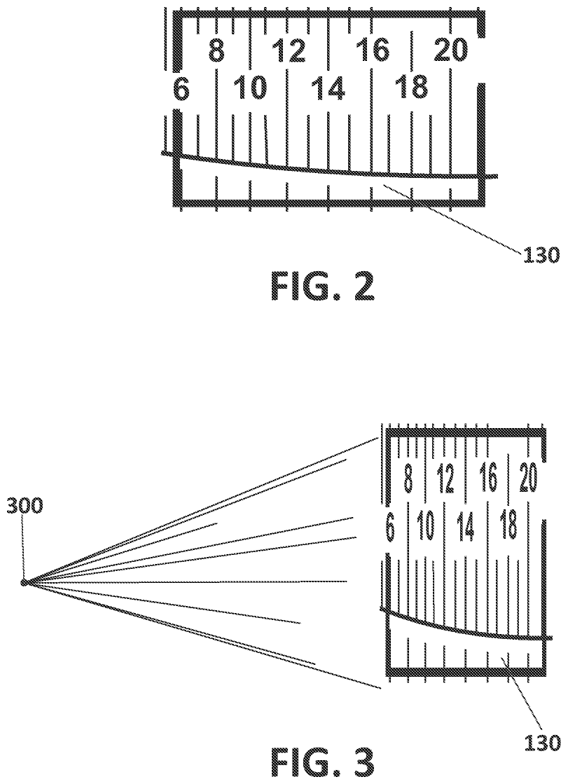

FIG. 2 shows the pattern section 130 selected to be projected by the projector (not shown in this figure). The pattern section 130 includes numerical references to structural items located behind the fuselage of the aircraft, e.g. frames, systems supports, longerons, etc.

FIG. 3 shows a projection 300 of the pattern section 130. The projection 300 is performed by the proposed projector on the outer surface of the fuselage of the aircraft in order to map out structural items behind the fuselage and which are identified by the numerical structural references included in the pattern section 130.

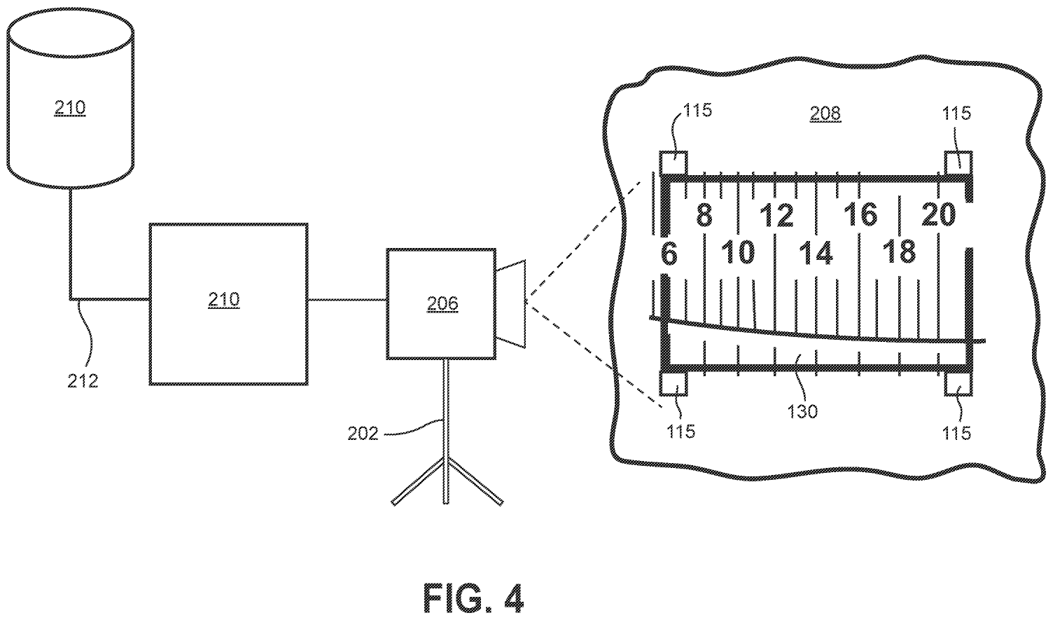

FIG. 4 illustrates a portable computing system 200 mounted to a tripod 202 near an aircraft 204. The computing system includes a projector 206 that projects a pattern section 130 onto a portion 208 of the skin of the fuselage. The section 130 identifies components, such as stringers and formers and stringers, adjacent or near an inside surface of the fuselage onto which the pattern is projected. The projected section 130 is retrieved, e.g., downloaded, by the computing system 200 from an electronic storage device that stores an electronic pattern of, for example, all structures adjacent or near an inside surface of the skin of a fuselage, wing or other section of an aircraft. The retrieval may be by a wired or wireless path 212, and the path may include access via the internet.

The projected section 130 is aligned with the fuselage by adjusting the projection to align with known frame reference points 115 visible on the outside of the fuselage. The projected sections 130 may include images of the frame reference points 115. The frame reference points 115 may be at or near the outer edges of the projected section or at two, three or more locations within the projected section 130.

The computer system and projector, automatically or manually, adjust the projected section to align the physical reference points on the fuselage with the projected frame reference points 115 in the projected section. The adjustment of the projected section may include enlarging or shrinking, e.g., zooming in or out, the projected section, shifting the section along the fuselage, and retrieving portions of the stored patterns of the entire fuselage to correspond to the physical reference points on the portion of the fuselage on which the projected section 130 is to be projected.

Even though reference has been made to a specific embodiment of the invention, it is obvious for a person skilled in the art that the lightning protector described herein is susceptible to numerous variations and modifications, and that all the details mentioned can be substituted for other technically equivalent ones without departing from the scope of protection defined by the attached claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A projector assembly configured to project images on a fuselage of an aircraft, the projector comprising:
a computer system configured access an electronically stored pattern of structures adjacent or near an inside surface of a skin of the fuselage and configured to select a selected pattern which is a portion of the stored pattern;
a projector controlled by the computer system and configured to project the selected pattern as onto the fuselage;
wherein the selected pattern includes:
structural references representative of structural components adjacent or near an inside surface of the skin of the fuselage; and
frame references that correspond to predetermined visible points on the skin of the fuselage;
wherein the frame references are aligned with the predetermined visible points of the fuselage to align the selected pattern with the skin of the fuselage, and
wherein, while the frame references of the selected portion are aligned with the predetermined visible points of the fuselage, the structural references in the selected patter are aligned with corresponding ones of the structural components of the fuselage.

2. The projector assembly of claim 1, further comprising optical and/or digital devices to zoom in/out the read pattern to scale the projected pattern to a desired size.

3. The projector assembly of claim 2, wherein the selected pattern further comprises coordinate axes suited to measure a scaling of the projected pattern.

4. The projector assembly of claim 1, further comprising a support device configured to support the projector and align the projector to face the predetermined visible points of the fuselage of the aircraft.

5. The projector assembly of claim 1, wherein the computer system includes an interface configured to communicate with a remote electronic storage device storing the stored pattern.

6. The projector assembly of claim 1, wherein the projector includes a high contrast projector.

7. The project assembly of claim 1, wherein the structural items of the aircraft comprise frames, stringers, joint means, longerons, fuselage mechanical supports and spars located behind the fuselage of the aircraft.

8. The project assembly of claim 1, wherein the selected pattern is based on clad thickness and stepping procedures of a composite skin of the fuselage of the aircraft.

9. The projector assembly of claim 4, wherein the support device includes a tripod configured to locate the projector to align the frame references with the predetermined visible points of the fuselage.

10. A method to identify identifying structural components of an aircraft that are adjacent or proximate an inside skin of a fuselage of the aircraft, the method comprising:
retrieving reading a first selected pattern which includes information identifying and locating the structural components and frame references that correspond to visible points on the fuselage;
projecting the first selected pattern onto the skin of the fuselage;
adjusting the projection of the first selected pattern to align the frame references with the corresponding visible points of the fuselage to match the first selected pattern with the aircraft; and
identifying and locating the structural components in the fuselage using the aligned projection of the first selected pattern displaying the information of the structural components.

11. The method of claim 10, further comprising:
projecting at least a second selected pattern with at least a second projector onto the skin of the fuselage,
adjusting the projection of the second selected pattern to align the frame references with the corresponding visible points of the fuselage to match the second selected pattern with the aircraft; and
overlapping the second selected pattern with the first selected pattern to obtain an overlapped pattern projected onto the skin, and
identifying and locating the structural components in the fuselage using the aligned projection of the overlapping first and second selected patterns displaying the information of the structural components.
